(19) United States
(12) Patent Application Publication
(10) Pub. No.: US 2012/0200774 A1
(43) Pub. Date: Aug. 9, 2012

(54) AUDIO AND VIDEO DISTRIBUTION SYSTEM WITH LATENCY DELAY COMPENSATOR

(76) Inventor: Gregory Allen Ehlers, SR., Dacula, GA (US)

(21) Appl. No.: 13/365,784

(22) Filed: Feb. 3, 2012

Related U.S. Application Data
(60) Provisional application No. 61/440,006, filed on Feb. 7, 2011.

(51) Int. Cl. H04N 9/475

(52) U.S. Cl. 348/515; 348/E09.034

(57) ABSTRACT

An audio/video distribution system and method for providing media to an end-user. The media has an audio component and a video component. At least the audio component is received and played at an end-user device. The system includes a controller, a display device and a synchronization tool. The controller generates a video signal and an audio signal. The display device is coupled to the controller for receiving and displaying the video signal. The synchronization tool is implemented at the end-user device and is configured to allow a user to synchronize playback of the audio signal at the end-user device to the display of the video signal at the display.

### RELATED APPLICATIONS

The present application claims priority to U.S. Provisional Patent Application 61/440,006, filed Feb. 7, 2011, which is hereby incorporated by reference.

### FIELD OF THE INVENTION

The present invention relates generally to an audio-video distribution system, and more particularly, to an audio-video system which includes an audio latency delay compensator.

### BACKGROUND OF THE INVENTION

The video display units or systems in most public locations like restaurants, bars or any other location, often are numerous in quantity and often are displaying different media content for the enjoyment of the patrons. A good example would be sports bars like Hooters, Wings, Hoops, Rick Tanners, Fatz, Fatso's or Beef O'Brady's where 10 different flat panel displays or TV's would be located around the perimeter of the bar and/or restaurant area with each unit displaying a different sporting event or channel. In most locations, the TV's are controlled by individual satellite receivers or cable boxes permitting each display to be tuned to any available content from their audio and/or video service provider. Some establishments choose to place all the satellite receivers in one location and then distribute the content from there but for this system the physical location is not material. In the future, distribution of media events over the Internet to an establishment for customer viewing may become more prevalent as well as the use of wireless WAN networks like 4G or Clear Networks or digital TV networks, therefore the system will also accommodate these sources of media content. No matter what the distribution means or the display configuration, the diversity and variety of content being displayed in a sports bar for example, makes it difficult for the patrons to hear the audio from any given display or TV. As a result they are limited to watching the event without the benefit of the audio. It is also a common practice for the proprietors and establishment owners to turn off the audio completely.

The present invention is aimed at one or more of the problems identified above.

### SUMMARY OF THE INVENTION

In one aspect of the present invention, an audio/video distribution system for providing media to an end-user is provided. The media has an audio component and a video component. The system includes a controller, a display device, and a synchronization tool. At least the audio component is received and played at an end-user device. The controller generates a video signal and an audio signal. The display device is coupled to the controller for receiving and displaying the video signal. The synchronization tool is implemented at the end-user device and is configured to allow a user to synchronize playback of the audio signal at the end-user device to the display of the video signal at the display.

In another aspect of the invention, a method of distributing media to user is provided. The media has an audio component and a video component. At least the audio component is received and played at the end-user device. The method includes the steps of generating an audio signal and a video signal using a controller and receiving and displaying the video signal at a display device. The display device is separate from the end-user device. The method also includes the step of allowing a user to synchronize playback of the audio signal at the end-user device to the display of the video signal at the display using a synchronization tool implemented at the end-user device.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1-1 is a block diagram of a system for providing media to an end-user, according to an embodiment of the present invention;

FIG. 1-2 is an environmental view of an establishment along with various audio/video feeds for user with the system of FIG. 1-1;

FIG. 2 is an illustration of a system for providing media to an end-user which receives audio-video signals via an over-the-air signal, according to an embodiment of the present invention;

FIG. 3 is an illustration of a system for providing media to an end-user which receives audio-video signals via a digital satellite signal, according to an embodiment of the present invention;

FIG. 4 is illustration of a system for providing media to an end-user which receives audio-video signals via an Internet digital data stream, according to an embodiment of the present invention;

FIG. 5 is illustration of a system for providing media to an end-user which receives audio-video signals via a cable television analog and digital signal, according to an embodiment of the present invention;

FIG. 6 is illustration of a system for providing media to an end-user which receives audio-video signals via a live digital data stream generated within an establishment, according to an embodiment of the present invention;

FIG. 7-0 is an illustration of as a sample end user device such as a smart phone or tablet device and a method for installing the appropriate application code (APP) into the device to work with the digital Audio and/or Audio/Visual system in the establishment, according to one embodiment of the present invention;

FIG. 7-1 is an illustration of the sample end user device of FIG. 7-0 showing an exemplary welcome screen; according to an embodiment of the present invention;

FIG. 7-2 is an illustration of the sample end user device of FIG. 7-0 showing a listing of available audio/video channels, according to an embodiment of the present invention;

FIG. 7-3 is an illustration of the sample end user device of FIG. 7-0 showing an audio latency delay compensator according to an embodiment of the present invention;

FIG. 8-1 is an illustration of a sample end user device such as a tablet showing an exemplary welcome screen, according to an embodiment of the present invention;

FIG. 8-2 is an illustration of the sample end user device of FIG. 8-1 showing a listing of available audio/video channels, according to an embodiment of the present invention;

FIG. 8-3 is an illustration of the sample end user device of FIG. 8-1 showing an audio latency delay compensator according to an embodiment of the present invention; and,

FIG. 9 is an illustration of operation of a control channel in an environment with multiple displays, according to an embodiment of the present invention.

### DETAILED DESCRIPTION OF INVENTION

Referring to the Figures, wherein like numerals indicate like or corresponding parts throughout the several views, a system 10 and method provides media to an end-user through an end-user device 12. The media has an audio component and a video component. As described below, at least the audio component is received and played at the end-user device 12. The system 12 includes a controller 14 for generating a video signal and an audio signal. A display device 16 is coupled to the controller 14 for receiving and displaying the video signal. A synchronization tool 18 implemented and provided at the end-user device 12. As explained more fully below, the synchronization tool 18 is configured to allow a user to synchronize playback of the audio signal at the end-user device to the display of the video signal at the display.

Generally, the system 10 and method operating in an predefined environment 20, such as a bar or restaurant. The environment 20 may include one display or multiple displays 16 spaced throughout. For example, the environment 20 could include a plurality of large displays or televisions, each displaying a different video stream. If a user wants to watch the video being displayed on a particular display 16, the user may choose that “channel” through an application or mobile application (“APP”) on their end-user device 12. As explained more fully below, the audio corresponding to the video being displayed on the chosen display 16 is played through (a speaker or headphones) on the user's end-user device 12. To make sure that the audio played at the end-use device 12 is synchronized with the video being played on the chosen display 16, the end-user device 12 is provided with a synchronization tool 18. In the illustrated embodiment, the synchronization tool 18 is provided as part of the APP.

In one embodiment, the audio signal is buffered within the end-user device 12. The synchronization tool allows the user to synchronize the playback of the audio component by allowing the user to scroll forward and backward within the buffered audio signal.

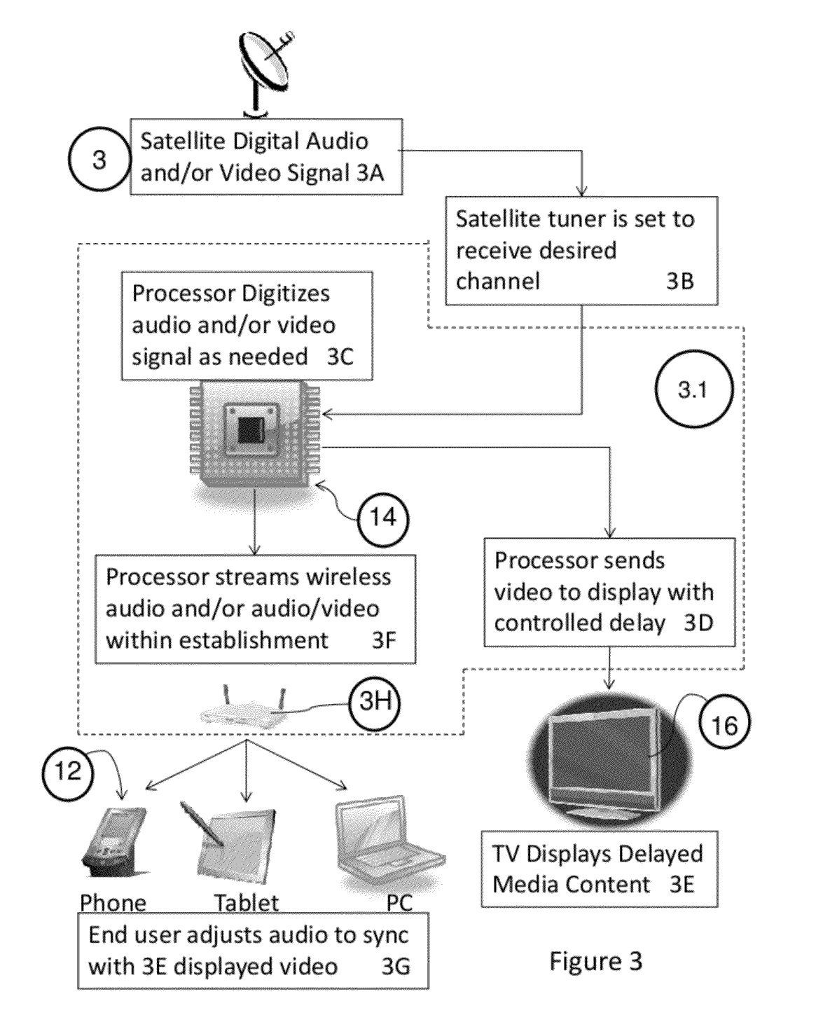

As shown in FIGS. 7-3 and 8-3, the synchronization tool 18 may include an adjustment member 7.3A, 8.3A which may be manipulated by the user to synchronize the playback of the audio signal with the display 16 of the video signal. The adjustment member 7.3A, 8.3A may be visually displayed as a wheel, a slide bar, the like, or any suitable means. Alternatively, a mechanical wheel, switch or the like may also be provided.

In one embodiment, the controller may be configured to display a counter on the display device (see below). The synchronization tool displays an element actuatable by the user to indicate when the counter has reached a predetermined value. The synchronization tool is configured to playback the audio signal in response to the element being actuated. The adjustment member 7.3A, 8.3A may then be used to provide fine adjustment.

In one aspect of the present invention, the controller 14 is configured to receive an audio/video signal and to responsively separate the audio/video signal into the audio signal and the video signal. As explained more fully below, the audio/video signal may be received from any type of source, including, but not limited to satellite and/or cable television systems.

In one embodiment and as explained more fully below, the audio signal may be transmitted wirelessly to the end-user device 12. In another embodiment, the audio signal may be transmitted to the end-user device 12 through a computer network, such as, but not being limited to the Internet.

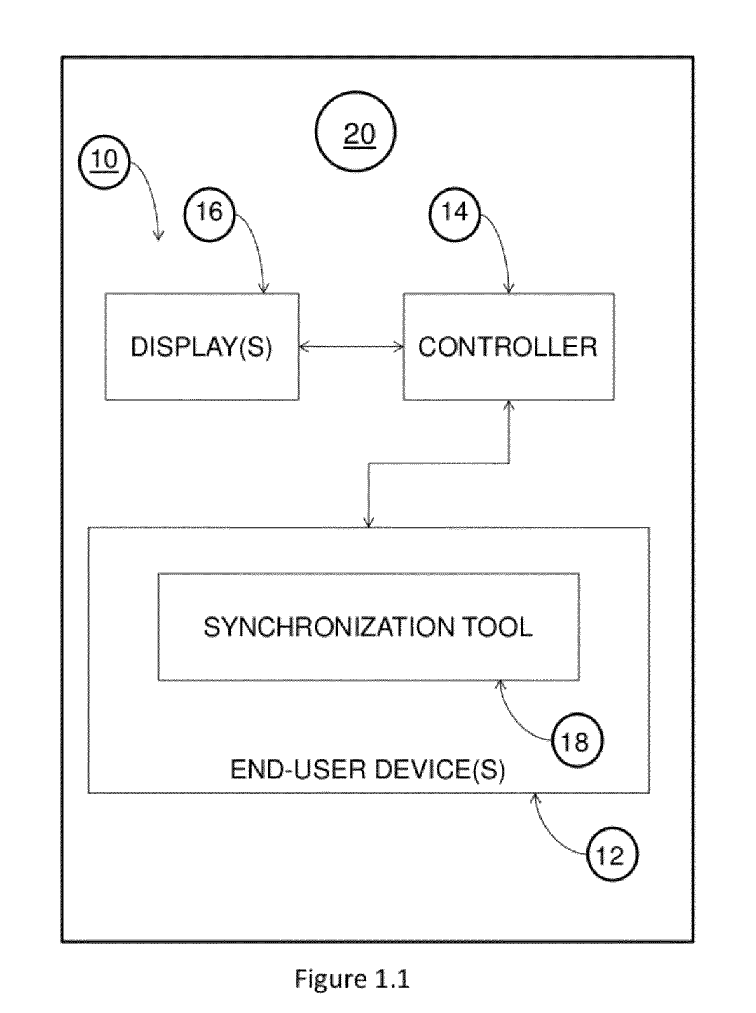

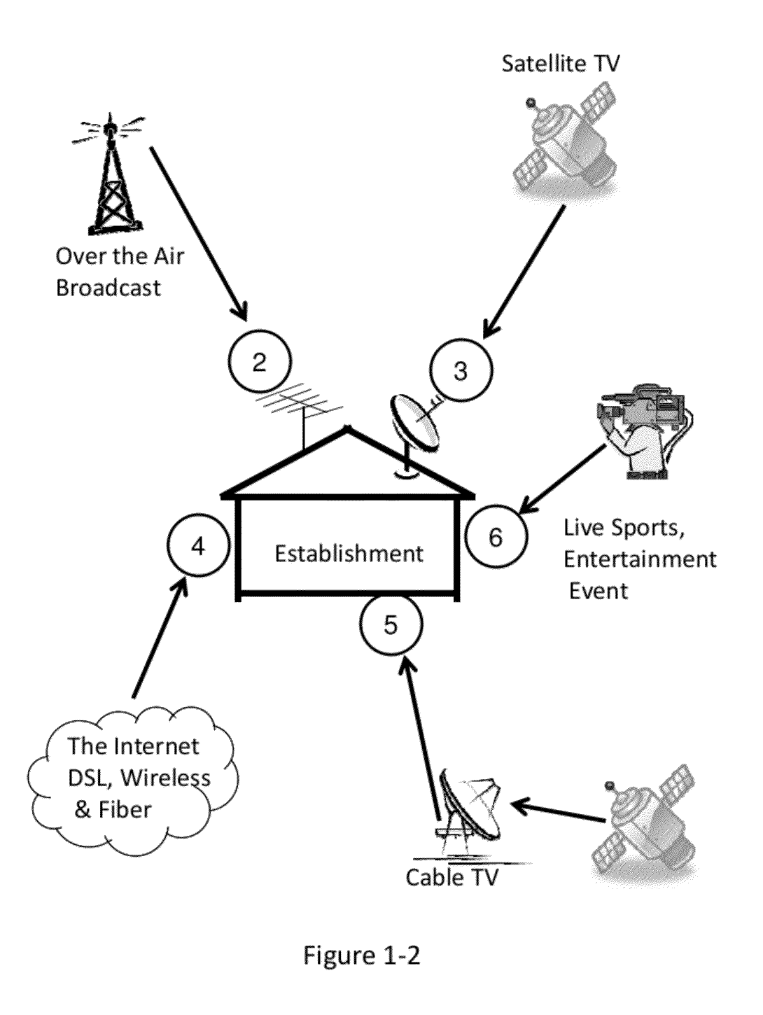

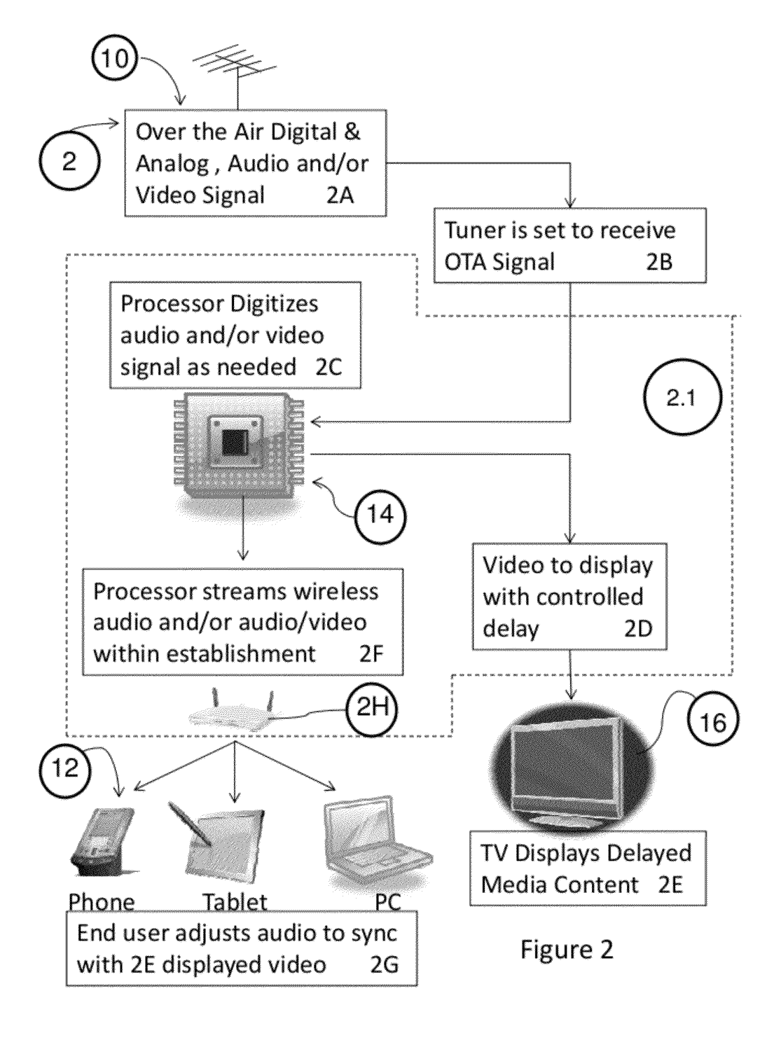

FIG. 1-2 shows an establishment 20 which could be a home, a bar or restaurant or a larger geography like an arena or stadium. An establishment 20 as used in this disclosure is not intended to be larger than sport stadium or area or cover any large geographic area. FIG. 1-2 illustrates any number of analog or digital audio and/or audio and video feeds coming into the home, or in the case of a stadium or area may be generated and distributed within the establishment 20 and not come from an outside source. Possible feeds include, but are not limited to, Over-The-Air digital and or analog media 2, Satellite TV digital feeds like Dish TV or Direct TV in the U.S. 3, Audio or audio/video 4 streamed to the establishment using the Internet, Analog or Digital media distributed by a Cable TV company to an establishment over a network 5, A live sports event where audio and/or audio/video feeds are steamed to the participants of the event either as a free or fee service 6.

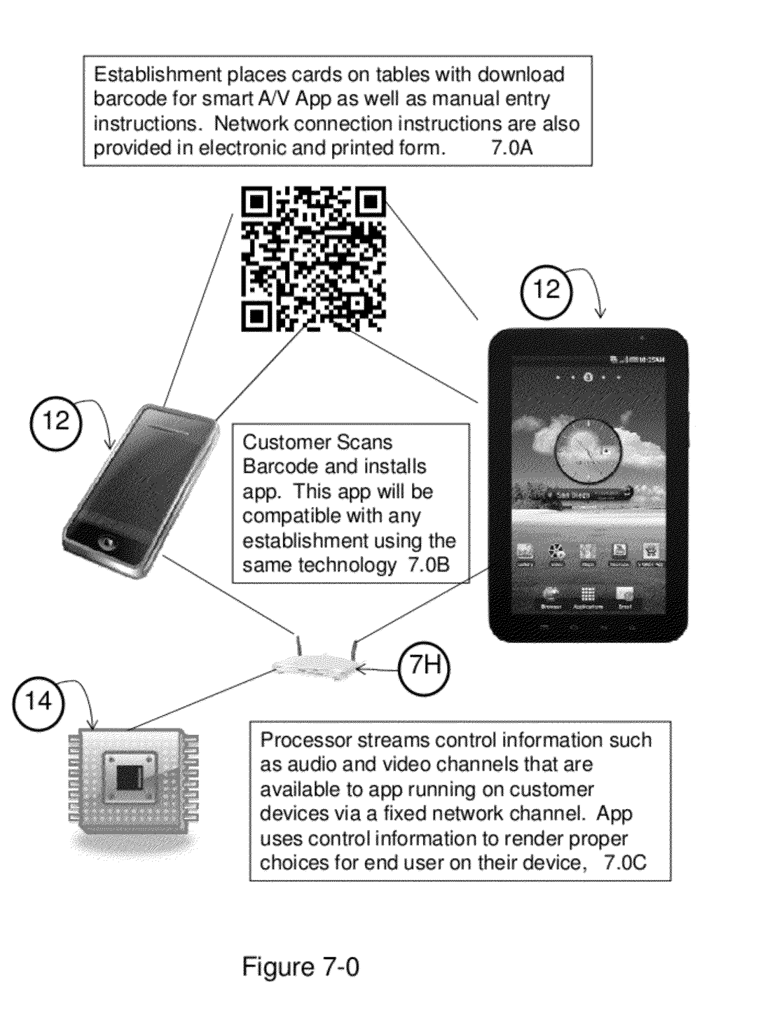

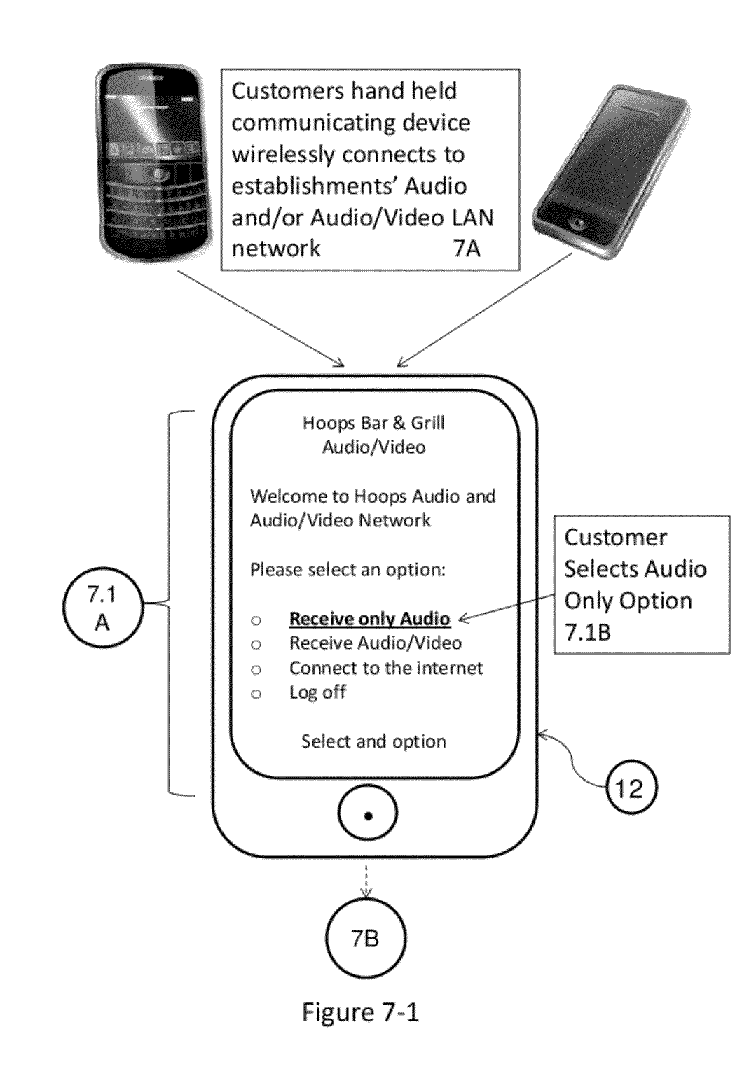

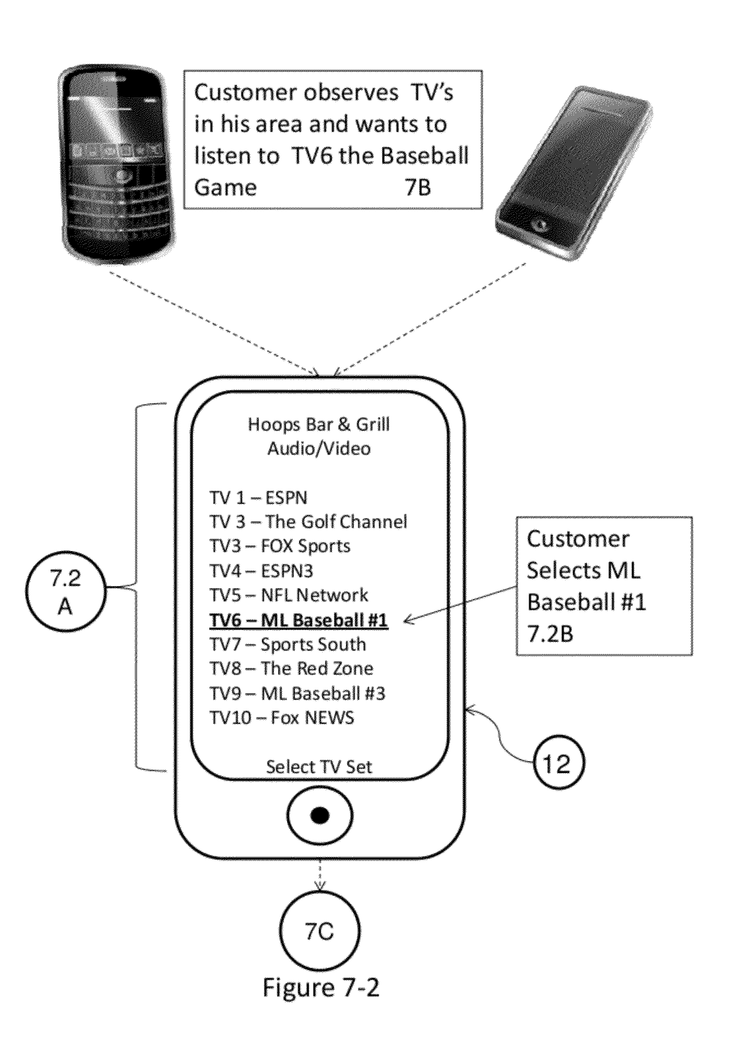

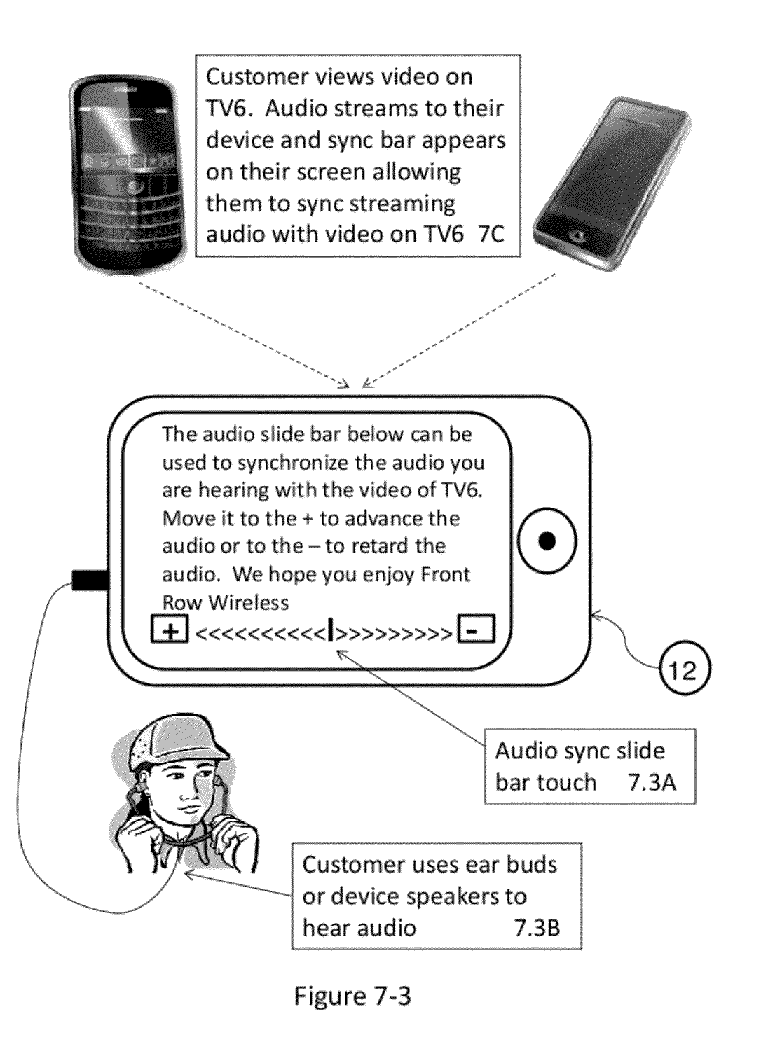

FIG. 2 depicts the invention in use when an Over-The-Air signal 2 is received at an establishment 2A and then routed to a tuner 2B where specific channels or feeds are isolated and channeled to a processor 2C, i.e., the controller 14. The processor 2C digitizes analog audio and video signals as needed and places them into both a TV display ready format as well as a wireless digital network transmission format utilizing a common network protocol such as Internet protocol. The processor 2C has the option of creating two digital format media data streams, the first one consisting only of audio data and the second one consisting of combined audio and video media content. Depending on the needs and configuration of the system 10 either of the options or both may be created. The end user, using their end user device 12 has the option to choose either audio only or audio/video feeds from the processor 2C (FIG. 7-1; step 7.1A). The audio only data stream requires less bandwidth to distribute and therefore uses less energy or battery power at the end user device 12. The processor 2C has two primary methods of distributing the audio and/or audio/video content to the end user using common network protocols over the wireless network. First, the content can be packetized and sent to each end user device 12 individually or, because of the proximity of the end user to the processor 2C and transmitter router 2H, the packetized data can be broadcast using any of a number of wireless network standards or protocols. A preferred embodiment would have the audio and/or audio/video packets, depending on the configuration, broadcast within the establishment using IEEE 802.11 WIFI transmission means using Internet User Datagram Protocol (UDP) protocol through designated ports. As a result TV set #6 in a fictitious bar which is covering the baseball game would have its associated processor 2C transmitting the digital audio only signal through port 8000 and the combined audio/video stream would be simultaneously being broadcast through port 10,000 by the transmitter/router 2H means. At the same time as the processor 2C is sending wireless steaming data to the end user, it is also streaming the video content to TV set #6 2D in the establishment 20 with a built in programmable delay. The delay imposed by the processor 2C on the incoming video signal before it is displayed on the TV screen/display 2D provides sufficient time for the processor 2C to perform its conversion, digitization as needed, packetizing of data, placement into appropriate Internet formats and transmission 2E to the end user device 12 so that the audio content is available for the end user to hear before the video image appears on TV set #6 at step 2E. The intentionally delayed video in most cases will be out of sync with the audio signal and therefore the end user is provided with a manual method 2G for advancing or retarding the audio playback so that it is in sync with the video. An automated means of providing this synchronization is also disclosed as an option (not shown). The delay can also be automatically adjusted based upon various parameters that affect the overall performance of the system 10 such as number of registered users currently accessing the system 10. The automated synchronization would provide a time stamp means through a control channel or embedded in the streaming data generated and transmitted by the processor or any other number of other ways to meet the needs and objectives of the synchronization process. The time stamp would be received by the end user device 12 which would contain the projected time delay that will be imposed by the processor 2C on the video being sent to the TV 16. By knowing the projected time delay, the end user device 12 can automatically apply that delay to the audio steam playback output making the audio in very close proximity to the video image being displayed on TV set #6 16. In an alternative embodiment of the system 12, the computed latency delay can simply be imposed on the video signal being sent to the display unit 16 being watched by the premise patron eliminating the need for sending a synchronization signal or time offset to the end user device 12. In this case the manual synchronization adjustment tool at the end user device 12 would ideally still be included to fine tune the synchronization process. The projected time delay can also be applied to the center point adjustment means for the manual synchronization process 2G (implemented as the synchronization tool) to permit minor adjustments to be made more easily by placing the mid-point of the adjustment means as close as possible to the exact synchronization point. It should be noted that all of the processes outlined in the drawing by the dashed line and labeled 2.1 could be packaged together within the TV set or within transmitter device 2H. By fully integrating the disclosed invention into the TV set 2E or transmitter 2H, the installation and manufacturing of either option can be simplified and cost reduced.

FIG. 3 depicts the invention in use with a Digital Satellite signal which is received at an establishment 3A and then routed to a tuner 3B where specific channels or feeds are isolated and forwarded to a processor 3C. The processor 3C will take the digitized audio and video signals and places them into both TV display ready formats as well as digital wireless network transmission formats. The processor 3C has the option of creating two digital network format media streams, the first one consisting only of audio data and the second one consisting of combined audio and video media content. Depending on the needs and configuration of the system either of the options or both may be created. The end user, using their end user device 12 has the option to choose either audio only or audio/video feeds from the processor 3C (FIG. 7-1; step 7.1A). The audio only data stream requires less bandwidth to distribute and uses less energy or battery power at the end user device. The processor 3C has two primary methods of distributing the audio and/or audio/video content to the end user using common network protocols over the wireless network. First, the content can be packetized and sent to each end user device 12 individually or, because of the proximity of the end user to the processor 3C and transmitter, the packetized data can be broadcast using any of a number of wireless network standards or protocols. A preferred embodiment would have the audio and/or audio/video packets, depending on the configuration, broadcast within the establishment using IEEE 802.11 WIFI transmission means using Internet UDP protocol through designated ports. As a result TV set #6 16 in a fictitious bar 20 which is covering the baseball game would have its associated processor transmitting the digital audio only signal through port 8000 and the combined audio/video stream would be simultaneously being broadcast through port 10,000 by the transmitter/router 3H means. At the same time as the processor 3C is sending wireless steaming data to the end user, it is also streaming the video content to TV set #6 (3D) 16 in the establishment 20 with a built in programmable delay. The delay imposed by the processor 3C on the incoming video signal before it is displayed on the TV screen provides sufficient time for the processor 3C to perform its conversion, digitization as needed, packetizing of data, placement into appropriate Internet formats and transmission 3E to the end user device 12 so that the audio content is available for the end user to hear before the video image appears on TV set #6 16 at step 3E. The intentionally delayed video in most cases will be out of sync with the audio signal and therefore the end user is provided with a manual method 3G, implemented as the synchronization tool, for advancing or retarding the audio playback so that it is in sync with the video. It should be noted that with many satellite digital distribution systems today, the audio is some times out of sync with the event. This is most obvious when there are people on the screen talking like in a movie. This out of sync audio and video signal needs to be corrected but the current satellite receivers do not provide such user control. An automated means of providing this synchronization is also disclosed as an option (not shown). The delay can also be automatically adjusted based upon various parameters that affect the overall performance of the network such as number of registered users currently accessing the system 10. The automated synchronization would provide a time stamp means through a control channel or embedded in the streaming data generated and transmitted by the processor 3C or any other number of other ways to meet the needs and objectives of the synchronization process. The time stamp would be received by the end user device 12 which would contain the projected time delay that will be imposed by the processor 3C on the video being sent to the TV. By knowing the projected time delay, the end user device 12 can automatically apply that delay to the audio steam playback output making the audio in very close proximity to the video image being displayed on TV set #6 16. The projected time delay can also be applied to the center point adjustment means for the manual synchronization process 3G to permit minor adjustments to be made more easily by placing the mid-point of the adjustment means as close as possible to the exact synchronization point. In an alternative embodiment of the system 10, the computed latency delay can simply be imposed on the video signal being sent to the display unit 16 being watched by the premise patron eliminating the need for sending a synchronization signal or time offset to the end user device 12. In this case the manual synchronization adjustment tool at the end user device 12 would ideally still be included to fine tune the synchronization process. It should be noted that all of the processes outlined in the drawing by the dashed line and labeled 3.1 could be packaged together within the TV set 3E or within satellite receiver 3B. By fully integrating the disclosed invention into the TV set or satellite receiver, the installation and manufacturing of either option can be simplified and cost reduced.

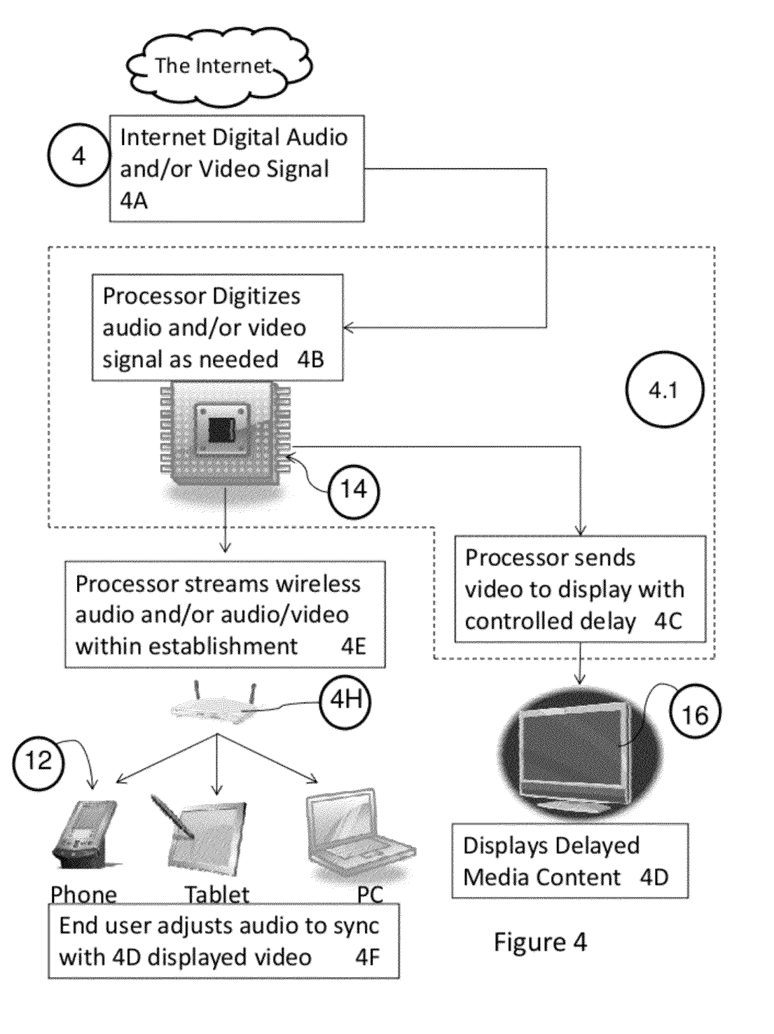

FIG. 4 depicts the invention in use with an Internet digital data stream being received at an establishment 4A and then routed to a processor 4B. The processor 4B modifies as needed, the digitized audio and video signals into both a TV display ready format as well as digital wireless network transmission format. The processor 4B has the option of creating two digital network format media streams, the first one consisting only of audio data and the second one consisting of combined audio and video media content. Depending on the needs and configuration of the system 10 either of the options or both may be created. The end user, using their end user device 12 has the option to choose either audio only or audio/video feeds from the processor 4B (FIG. 7-1; step 7.1A). The audio only data stream requires less bandwidth to distribute and uses less energy or battery power at the end user device 12. The processor 4B has two primary methods of distributing the audio and/or audio/video content to the end user using common network protocols over the wireless network. First, the content can be packetized and sent to each end user device 12 individually or, because of the proximity of the end user to the processor 4B and transmitter 4H, the packetized data can be broadcast using any of a number of wireless network standards or protocols. A preferred embodiment would have the audio and/or audio/video packets, depending on the configuration, broadcast within the establishment using IEEE 802.11 WIFI transmission means using Internet UDP protocol through designated ports. As a result TV set #6 16 in a fictitious bar 20 which is covering the baseball game would have its associated processor transmitting the digital audio only signal through port 8000 and the combined audio/video stream would be simultaneously being broadcast through port 10,000 by the transmitter/router 4H means. At the same time as the processor 4B is sending wireless steaming data to the end user, it is also streaming the video content to TV set #6 4D in the establishment 20 with a built in programmable delay. The delay imposed by the processor 4B on the incoming video signal before it is displayed on the TV screen/display 16 provides sufficient time for the processor 4B to perform its conversion, digitization as needed, packetizing of data, placement into appropriate Internet formats and transmission 4E to the end user device 12 so that the audio content is available for the end user to hear before the video image appears on TV set #6 at step 4D. The intentionally delayed video in most cases will be out of sync with the audio signal and therefore the end user is provided with a manual method 4F, i.e., the synchronization tool, for advancing or retarding the audio playback so that it is in sync with the video. An automated means of providing this synchronization is also disclosed as an option (not shown). The delay can also be automatically adjusted based upon various parameters that affect the overall performance of the system 10 such as number of registered users currently accessing the system 10. The automated synchronization would provide a time stamp means through a control channel or embedded in the streaming data generated and transmitted by the processor 4B or any other number of other ways to meet the needs and objectives of the synchronization process. The time stamp would be received by the end user device 12 which would contain the projected time delay that will be imposed by the processor 4B on the video being sent to the TV 16. By knowing the projected time delay, the end user device 12 can automatically apply that delay to the audio steam playback output making the audio in very close proximity to the video image being displayed on TV set #6 16. The projected time delay can also be applied to the center point adjustment means for the manual synchronization process 4F to permit minor adjustments to be made more easily by placing the mid-point of the adjustment means as close as possible to the exact synchronization point. In an alternative embodiment of the system 12, the computed latency delay can simply be imposed on the video signal being sent to the display unit 16 being watched by the premise patron eliminating the need for sending a synchronization signal or time offset to the end user device 12. In this case the manual synchronization adjustment tool at the end user device 12 would ideally still be included to fine tune the synchronization process. It should be noted that all of the processes outlined in the drawing by the dashed line and labeled 4.1 could be packaged together within the TV set 4D or within the transmitter device 4E. By fully integrating the disclosed invention into the TV set or transmitter 16, the installation and manufacturing of either option can be simplified and cost reduced.

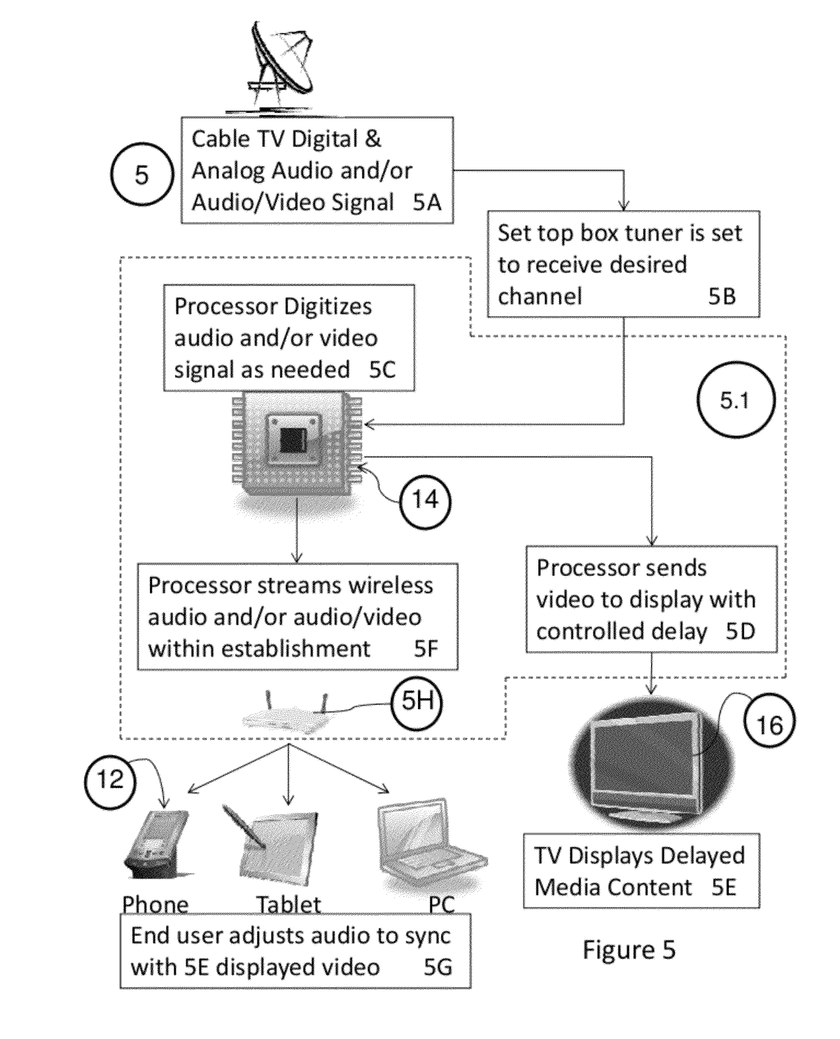

FIG. 5 depicts the invention in use with a Cable TV analog and digital signal which is received at an establishment 5A and then routed to a tuner 5B where specific channels or feeds are isolated and forwarded to a processor 5C. The processor 5C takes the audio and video feeds which may be in either digital or analog format converts them as needed into all digital format. The processor 5C then places the media content into both TV display ready formats as well as digital wireless network transmission formats. The processor 5C has the option of creating two digital network format media streams, the first one consisting only of audio data and the second one consisting of combined audio and video media content. Depending on the needs and configuration of the system 10 either of the options or both may be created. The end user, using their end user device 12 has the option to choose either audio only or audio/video feeds from the processor 5C (FIG. 7-1; step 7.1A). The audio only data stream requires less bandwidth to distribute and uses less energy or battery power at the end user device 12. The processor 5C has two primary methods of distributing the audio and/or audio/video content to the end user using common network protocols over the wireless network. First, the content can be packetized and sent to each end user device 12 individually or, because of the proximity of the end user to the processor and transmitter, the packetized data can be broadcast using any of a number of wireless network standards or protocols. A preferred embodiment would have the audio and/or audio/video packets, depending on the configuration, broadcast within the establishment 20 using IEEE 802.11 WIFI transmission means using Internet UDP protocol through designated ports. As a result TV set #6 16 in a fictitious bar 20 which is covering the baseball game would have its associated processor transmitting the digital audio only signal through port 8000 and the combined audio/video stream would be simultaneously being broadcast through port 10,000 by the transmitter/router 5H means. At the same time as the processor 5C is sending wireless steaming data to the end user, it is also streaming the video content to TV set #6 5D in the establishment 20 with a built in programmable delay. The delay imposed by the processor 5C on the incoming video signal before it is displayed on the TV screen 16 provides sufficient time for the processor 5C to perform its conversion, digitization as needed, packetizing of data, placement into appropriate Internet formats and transmission 5E to the end user device 12 so that the audio content is available for the end user to hear before the video image appears on TV set #6 at step 5E. The intentionally delayed video in most cases will be out of sync with the audio signal and therefore the end user is provided with a manual method 5G, implemented as the synchronization tool, for advancing or retarding the audio playback so that it is in sync with the video. It should be noted that with many digital distribution systems and networks today, the audio is some times out of sync with the event. This is most obvious when there are people on the screen talking like in a movie. This out of sync audio and video signal needs to be corrected but the current cable set top box receivers do no provide any such user control. An automated means of providing this synchronization is also disclosed as an option (not shown). The delay can also be automatically adjusted based upon various parameters that affect the overall performance of the system 10 such as number of registered users currently accessing the system 10. The automated synchronization would provide a time stamp means through a control channel or embedded in the streaming data generated and transmitted by the processor 5C or any other number of other ways to meet the needs and objectives of the synchronization process. The time stamp would be received by the end user device 12 which would contain the projected time delay that will be imposed by the processor 5C on the video being sent to the TV 16. By knowing the projected time delay, the end user device 12 can automatically apply that delay to the audio steam playback output making the audio in very close proximity to the video image being displayed on TV set #6 16. The projected time delay can also be applied to the center point adjustment means for the manual synchronization process 5G to permit minor adjustments to be made more easily by placing the mid-point of the adjustment means as close as possible to the exact synchronization point. In an alternative embodiment of the system 10, the computed latency delay can simply be imposed on the video signal being sent to the display unit 16 being watched by the premise patron eliminating the need for sending a synchronization signal or time offset to the end user device 12. In this case the manual synchronization adjustment tool at the end user device 12 would ideally still be included to fine tune the synchronization process. It should be noted that all of the processes outlined in the drawing by the dashed line and labeled 5.1 could be packaged together within the TV set or within the cable TV receiver 5B. By fully integrating the disclosed invention into the TV set or cable TV receiver, the installation and manufacturing of either option can be simplified and cost reduced.

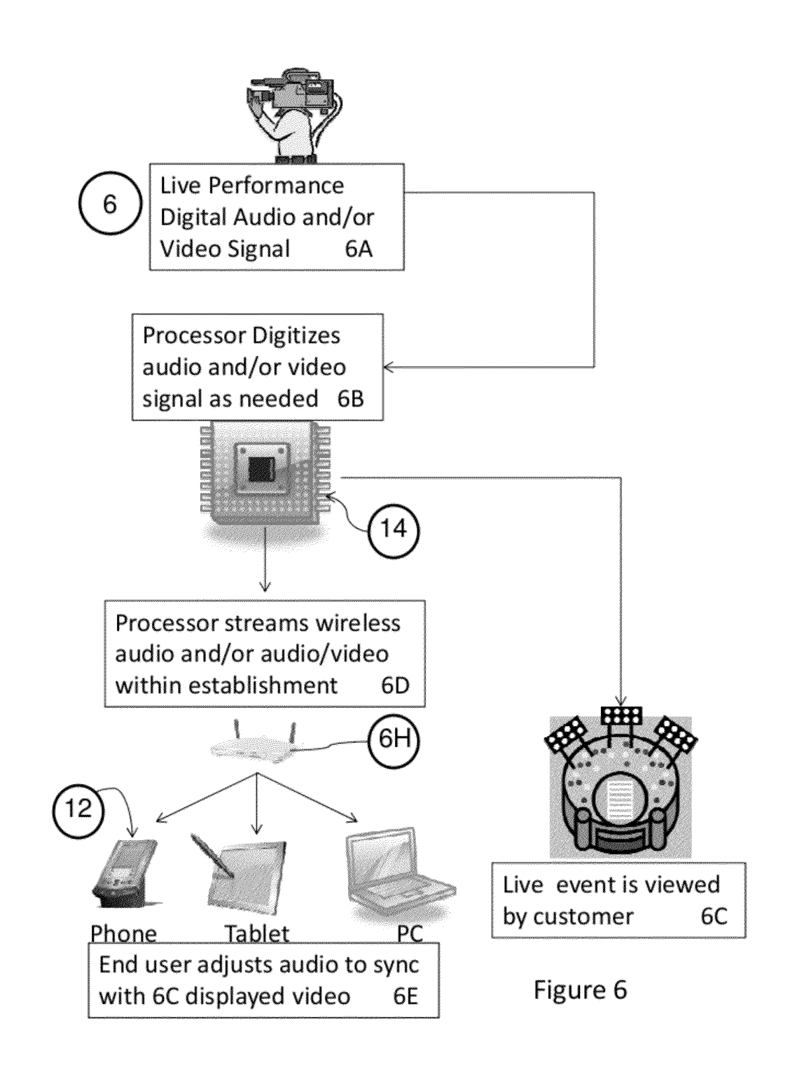

FIG. 6 depicts the invention in use with a live digital data stream being generated within an establishment 6A and then routed to a processor 6B. The processor 6B modifies as needed, the digitized audio and video signals for transmission over a digital wireless network. The processor 6B has the option of creating two digital network format media streams, the first one consisting only of audio data and the second one consisting of combined audio and video media content. Depending on the needs and configuration of the system 10 either of the options or both may be created. The end user, using their end user device 12 has the option to choose either audio only or audio/video feeds from the processor 6B (FIG. 7-1; step 7.1A). In a live performance this service may be a for fee value added service provided by the event promoter and for which a fee and authorization process will be required (not shown). The audio only data stream requires less bandwidth to distribute and uses less energy or battery power at the end user device 12. The processor in a live performance has only one method of distributing the audio and/or audio/video content to the end user using common digital network protocols over the wireless network. As a result of the live performance being viewed 6C, the system 10 cannot utilize the forced delay used in all of the other installation examples. You cannot delay a live performance. As a result, the packetized digital data will be broadcast using any of a number of wireless network standards or protocols directly to the end user. In one embodiment, the system 10 would have the audio and/or audio/video packets, depending on the configuration, broadcast within the establishment 20 using IEEE 802.11 WIFI transmission means using Internet UDP protocol through designated ports. As a result the live performance being captured by a closed circuit TV would have its associated processor 6B transmitting the digital audio only signal through port 8000 and the combined audio/video stream would be simultaneously being broadcast through port 10,000 by the transmitter/router 6D means. The delay caused by the digitization and transmission process in this example should be minimal however the end user is provided with a manual method 6E, using the synchronization tool 18, for advancing or retarding the audio playback to provide some turning of the audio with the live performance to get it in sync with the actual audio delay from caused by the customers distance from the sound system of the establishment 20. It is the intent of this live audio and audio/video feed to provide a value added service to the customer and give them the opportunity to have a better audio experience and also to be able to view the venue from alternate locations though the eye of alternate camera angles and locations. To accomplish the different views of the event the TV selection screen of FIG. 7-2; 7B would be replaced with location descriptions such as “behind home plate” or “front row” or “on stage with the drummer”. As an additional value added service the end user can request and receive digitally over the wireless network or at a later time over the Internet a copy of the performance. The copy would be down loaded to their end user device 12, once the performance is completed and any fees associated with either the audio and/or audio/video presentation have been paid. It should be noted that all of the processes outlined in the drawing and described herein as the processor 6B and transmitter 6D could be combined within the transmitter device 6D. By fully integrating the disclosed invention into the transmitter, the installation and manufacturing can be simplified and cost reduced.

FIG. 7-0 depicts a sample end user device 12 such as a smart phone or tablet device and one method for installing the appropriate application code (APP) into that device 12 to work with the digital Audio and/or Audio/Visual system in the establishment 20. Establishment posts that they are compatible with XYZ Digital Audio and/or Audio/Video networks and the APP can be downloaded with the depicted barcode or optional Internet address. Once the device 12 connects to the establishment's wireless network and launches the appropriate APP, the APP automatically receives control information from the controller 14 on a fixed network channel. A preferred embodiment of this particular function would be implemented with Internet UDP protocol operating on a fixed port for all instances of this network implementation. The controller 14 would broadcast the control information in a continuous stream to all devices on the digital wireless network. Control information would include the name of the establishment 20, the options available for connection such as Audio only or Audio & Video, the names of the video displays 16 that can be synced with audio and optionally the name of the program currently being displayed, timing information to assist the automatic synchronization functions, and even targeted messages to the customer to allow the owner of the establishment to extend their communications with their customers. While the APP is running, updated messages could be displayed either on the screen of the device 12 while in audio mode, or superimposed on the video image if audio/video mode were selected.

FIGS. 7-1 thru 7-3 depicts a sample end user device 12 such as a smart phone which is being used to connect to and receive audio media in an establishment 20, such as one of the above mentioned (FIGS. 2-6) venues. While a smart phone is used in the example the disclosed system will work with any device 12 that is capable of working on a wireless network with or without a display screen including but not limited to a tablet PC, netbook, iPod, or a laptop computer. In its simplest form, the device 12 could be a simple receiver with no display capability and no transmitter that scans all available streaming ports for UDP steaming audio data and plays it through a set of ear buds or other sound emitting means for the enjoyment of the end user. This simple form could be a simple set of head phones with a receiver, a button means to cause the turner to scan for the next available signal in a looping scan process and may optionally have a knob or thumb control rotary means to advance or retard the playback media it receives. The simplest form could also have a single button that when pressed would scan for the next available streaming audio port on a network and plays it just like the scan feature on a car radio. For this figure, the device 12 of choice is a smart phone that has a touch screen and runs an application permitting it to interface with and interact with the Front Row Wireless™ system of an establishment 20. The application or APP is needed to establishing communications with the establishment wireless network 7A, sign onto the network and receive the welcome screen 7.1A. The end user will then select which option they wish to listen to. In the example welcome screen, 4 options are presented to illustrate primary selection options. The options presented are: Receive Only Audio, Receive Audio/Video, Connect to the Internet, and Log Off. While other options might be offered, these options present a reasonable selection for the basic Front Row Wireless™ system 10. In the example, the end use customer has selected the “Receive Only Audio” option. Once the selection has been made, the end user device 12 in this example would display the available audio only data streams 7.2A available for the end use customers listening pleasure. The end user will then select which option they wish to listen to based on what TV screens 16 they can see 7B in this example. It is not necessary that the customer be able to see the TV screen 16 to receive the audio being distributed but it does enhance the customers enjoyment if both are available. In the example, the available audio only option list provides 10 choices. The options presented here will be determined by the establishment 20 based on any number of marketing, customer demographics, and available services. In the example, the end use customer has selected 7.2B the “ML Baseball #1” option. Upon completion of the audio only selection, the end user will begin to receive 7C the steaming audio from the establishments 20 audio and/or audio/video distribution system 10. The end user device 12 will provide a means for the end user to synchronize the audio with the either the live event sound or the TV screen 16 in the establishment 20. In the example, a slide bar 7.3A appears on the end user device 12 giving the end user the ability to advance or retard the audio playback to be in sync with the actual event sound or the displayed video content. The streamed audio can be routed at the end users option to the speakers of the device or to any other means such as ear buds 7.3B or other popular ear mounted sound producing means such as a blue tooth enabled ear bud headset. At any time the end user can opt out of the selected event and switch back to the available option screens 7.1A, 7.2A. This figure presents an example of how the Front Row Wireless™ system 10 could be used in a typical sports bar or restaurant and is not meant to limit its use in other establishments such as a home, sports arena or stadium.

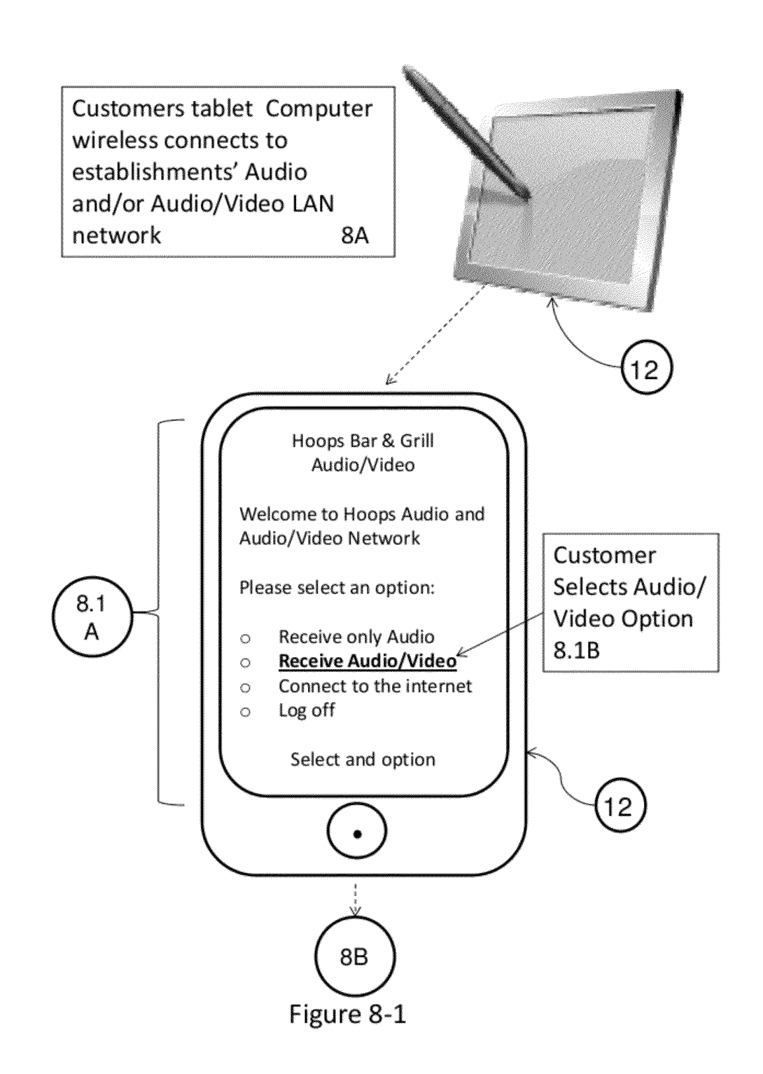

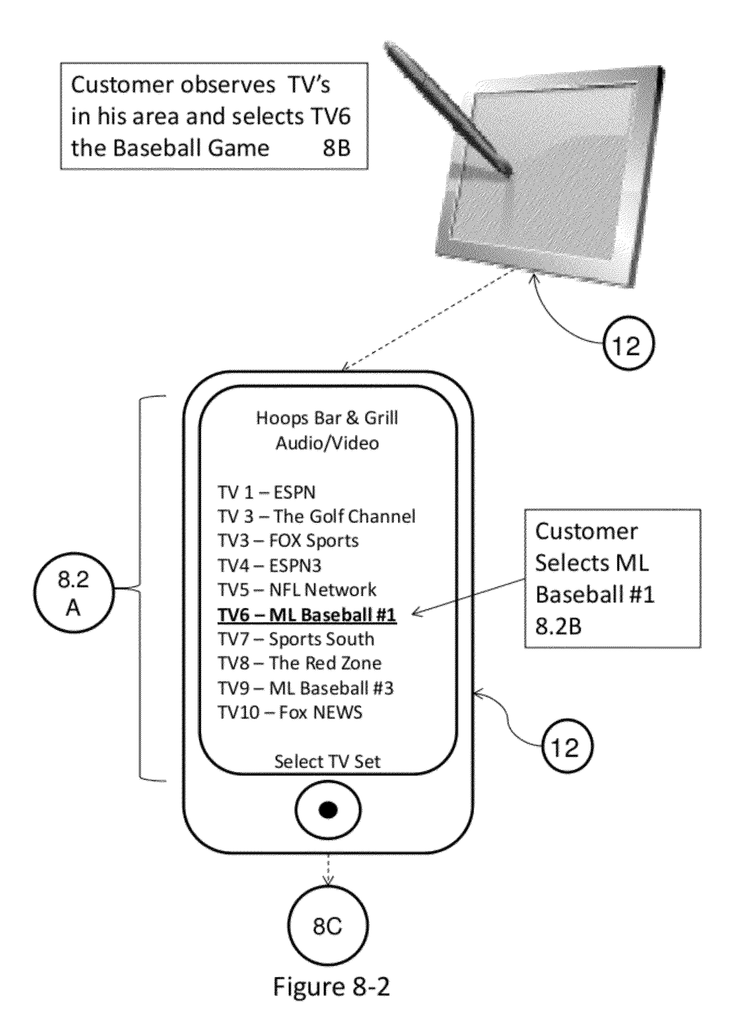

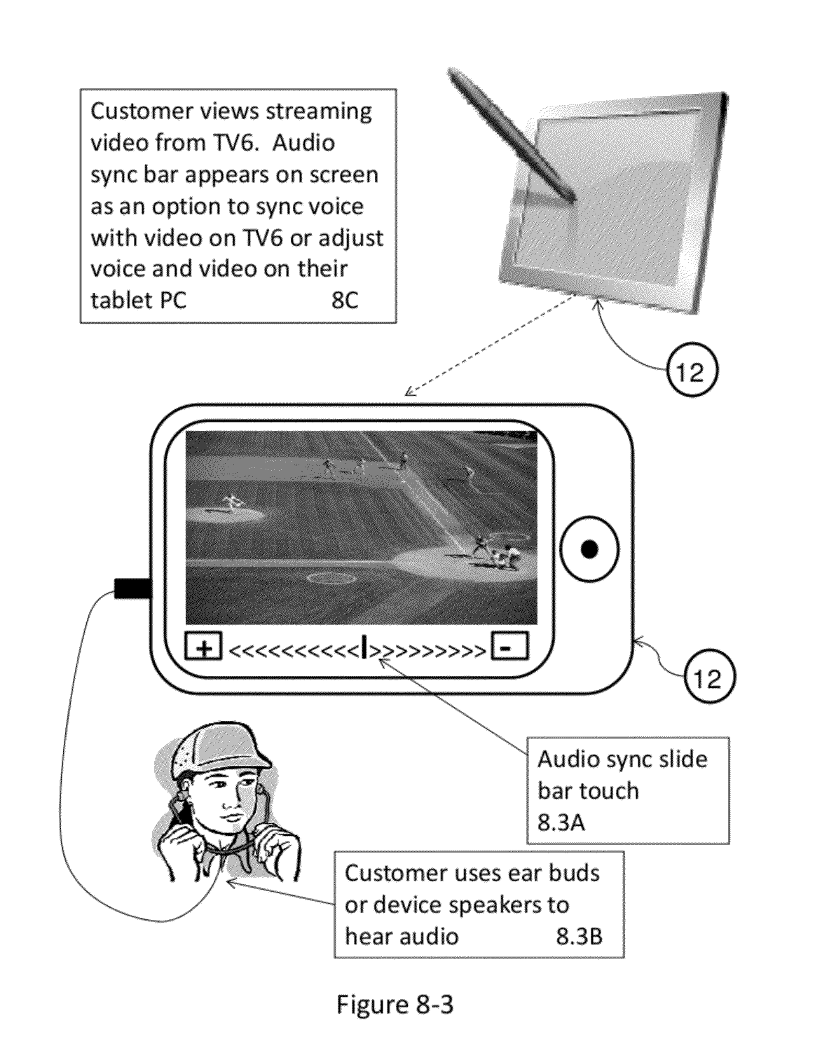

FIGS. 8-1 thru 8-3 depicts a sample end user device 12 such as a tablet PC, IPAD, or any number of the new Android Tablets now entering the market or any others that may evolve over time, which is being used to connect to and receive audio/video media in an establishment 20, such as one of the above mentioned (FIGS. 2-6) venues. While an IPAD is used in the example the disclosed system 10 will work with any device 12 that is capable of working on a wireless network with a display screen including but not limited to a smart phone or a laptop computer. In its simplest form, the device 12 could be a simple receiver with a display capability and no transmitter that scans all available streaming ports for UDP steaming audio/video data and displays the video on its screen and plays the audio through a set of ear buds or other sound emitting means for the enjoyment of the end user. The simplest form could also have a single button that when pressed would scan for the next available streaming port with audio/video data on a network and displays and plays it just like the scan feature on a car radio. For this figure, the device 12 of choice is an IPAD that has a touch screen and runs an application permitting it to interface with and interact with the Front Row Wireless™ system 10 of an establishment 20. The application or APP is needed to establishing communications with the establishment wireless network 8A, sign onto the network and receive the welcome screen 8.1A. The end user will then select which option they wish to watch and listen to. In the example welcome screen, 4 options are presented to illustrate primary selection options. The options presented are: Receive Only Audio, Receive Audio/Video, Connect to the Internet, and Log Off. While other options might be offered, these options present a reasonable selection for the basic Front Row Wireless™ system 10. In the example, the end use customer has selected the “Receive Audio/Video” option. Once the selection has been made, the end user device 12 in this example would display the available audio/video data streams 8.2A available for the end use customers viewing pleasure. The end user will then select which option they wish to watch based on what TV offers the select they would like to see. In this example 8B, the user decides he wants to watch the baseball game. It is not necessary that the customer be able to see the TV screen 16 to receive the audio/video being distributed but it does enhance the customers' enjoyment if both are available. In the example, the available audio/video options list provides 10 choices. The options presented here will be determined by the establishment 20 based on any number of marketing, customer demographics, and available services. In the example, the end use customer has selected 8.2B the “ML Baseball #1” option. Upon completion of the audio/video selection, the end user will begin to receive 8C the steaming audio and video from the establishments 20 audio and/or audio/video distribution system 10. The end user device 12 will provide a means for the end user to synchronize the audio on the end user device 12 with either the live event sound or the TV screen 16 in the establishment 20 (see above). A means is also provided within the audio and/or audio/video distribution system 10 for providing an automated corrective offset to the audio being streamed and the video appearing on the establishments 20 TV set 16. The offset is computed by the distribution system 10 and represents the lag time between the transmission of the audio/video stream to the end user device 12 and the transmission of the associated image on the establishments 20 TV screen 16. In the example, a slide bar 8.3A appears on the end user device 12 giving the end user the ability to advance or retard the audio playback to be in sync with the actual event sound or the displayed video content. The midpoint of the slide bar can be set automatically by the APP to represent the time offset computed by the distribution system 10 so that it is as close as possible to being in sync, requiring little if any adjustment by the end user. The streamed audio can be routed at the end user's option to the speakers of the device 12 or to any other means such as ear buds 8.3B or other popular ear mounted sound producing means such as a blue tooth enabled ear bud headset. At any time the end user can opt out of the selected event and switch back to the available option screens 8.1A, 8.2A. This figure presents an example of how the Front Row Wireless™ system 10 could be used in a typical sports bar or restaurant 20 and is not meant to limit its use in other establishments such as a home, sports arena, church, lecture hall, concert hall, auditoriums or stadium.

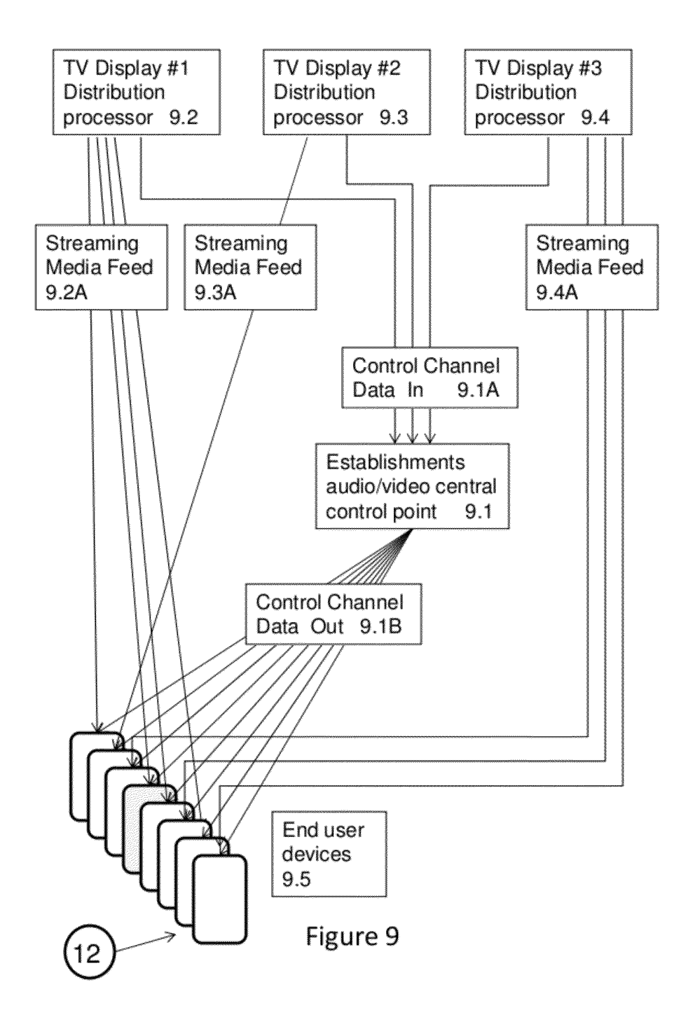

FIG. 9 provides more detail of how the control channel works within an establishment 20 with multiple TV's or display means 16 to provide end users' and their end user devices 12 with selection and control information. It should be noted that if FIG. 9 were a home with a single TV or display means 16 and the functions describing this control process and system would be combined into a single point of control. The illustrations of FIG. 9 equally apply to a live event where the TV's or display means 16 could be replaced by camera's capturing live images of the event from different viewpoints. The continued example of a sports bar 20 is used as a basis for this description. FIGS. 9.2-9.4 are TV sets or display means 16 used to display media content to patrons of a fictitious sports bar 20. In FIGS. 7.1 and 8.1, a patron of the establishment 20 would use their end user device 12 to select to receive either audio only or a combined audio/video feed from the establishments audio and/or audio/video distribution system 10. Once the patron or end user selects the type of feed they would like to receive, the next FIGS. 7.2A and 8.2A, respectively, would appear listing the currently available feeds from which the patron or end user would select. The control channel of FIG. 7.1 provides the end user device 12 with the list of available feeds. The control channel gets data from the processors 14 controlling the distribution of the audio and/or audio/video media associated with each of the display devices 16 such as is illustrated in FIG. 3C. The control channel device could be a stand alone device within the establishment 20 or may be associated with one of the TV's or display units 16 control processor such as 3C. Returning to FIG. 9, the control processor 9.1 collects information from each of the display processors 9.2 thru 9.4 over a wireless control channel 9.1A and distributes that data over the control channel 9.1B to all end user devices 9.5 in the establishment 20 that are running the Front Row Wireless App and are connected to the audio/video system 10. Each end user device 9.2 thru 9.4 of the example sends the control process 9.1 data related to the display points status over the control channel 9.1A. This could be limited to the TV sets ID such as TV #1 and its operational status such as “ON” and “Transmitting” and “Audio Only” or Audio/Video Only” or “Both Audio and Audio/Video”. Other data, if and when available, would also be included such as Content or Channel designation or name like “FOX Sports”, remaining time, start time, end time, rating, type of program and any other data useful and needed by the end user. The control channel process 9.1 would maintain all the data needed to display the selection options on the end user device 12 and the control information needed by the end user device 12 to connect to the audio and/or audio/video distribution process, such as the one illustrated in FIG. 3C, when selected by the end user. As a result, the end user device as illustrated in FIGS. 7.1A and 8.1A would connect to and receive data from the establishments 20 wireless control point 9.1 over control channel 9.1B related to its network and options available. The control point 9.1 would provide these options. If connection to the audio/video distribution system 10 for the establishment 20 is selected additional data would be used from the control point 9.1 using the control channel 9.1B related to the connection and distribution options available as illustrated in 7.2A and 8.2A. Along with the media feed options, the control channel would provide the end user device 12 with all connection data needed to listen to or watch and listen to a particular option. In a WIFI network example, this data would include but is not limited to, the transmitters channel the selected media feed is being transmitted over, the SSID of the transmitter and the port or ports through which the audio, and/or audio/video UDP steaming data packets will be sent. With this data, the end user device 12 can locate the correct transmitter, tune to the proper channel, associate itself with the transmitter and open the needed port or ports to receive and process the audio and/or audio/video feeds 9.2A through 9.4A. The control point and control channel also provide support for and management of any security features or functions needed to protect “for fee” or proprietary events and options. These features and functions are also supported by and managed by the Front Row Wireless App running on the end user device 12 in cooperation with the control point and control channel. This example is provide as a limited example and is not meant to limit the design or configuration of hardware or software or its placement or configuration. The design and layout of these components will be done in a manner to best meet the needs of the establishment 20, the end user and the end user device 12.

### Commercial Applicability

The invention discloses an audio and/or audio/video distribution system 10 for use in any private or public location where at least one TV or other video display unit or system 16 is present and it is desirable to provide a wireless distribution of the audio and/or audio/video media being displayed on in display units, so that patrons can enjoy the audio and/or audio and video content anywhere in the premise 20 on an end user device 12 carried by the patron. The invention takes into account latency delays that will be inherent in such a distribution system 10, permitting a dynamically variable controlled delay to synchronize the audio with the video within the premise or establishment 20, based on a number of variables. The latency delay imposed by the invention is necessitated by the fact that the original audio/video content is being split and sent over two different paths which introduces potential delays on either path. The original video is being sent to a video display unit 16 within the premise 20 while the audio and optionally the audio and video combined content is also being distributed over an in house wireless network to at least one end user device 12. The potential delay is never going to be an issue with the original video which is displayed on the in premise 20 device at its path is short and straight forward. The delays will occur on the redistribution of the audio and or audio and video streaming over the in house wireless network to the at least one end user device 12. The video display units or systems 16 in most public locations like restaurants, bars or any other location, often are numerous in quantity and often are displaying different media content for the enjoyment of the patrons. A good example would be sports bars like Hooters, Wings, Hoops, Rick Tanners, Fatz, Fatso's or Beef O'Brady's where 10 different flat panel displays or TV's would be located around the perimeter of the bar and/or restaurant area with each unit displaying a different sporting event or channel. In most locations, the TV's are controlled by individual satellite receivers or cable boxes permitting each display to be tuned to any available content from their audio and/or video service provider. Some establishments choose to place all the satellite receivers in one location and then distribute the content from there but for this system the physical location is not material. In the future, distribution of media events over the Internet to an establishment for customer viewing may become more prevalent as well as the use of wireless WAN networks like 4G or Clear Networks or digital TV networks, therefore the system will also accommodate these sources of media content. No matter what the distribution means or the display configuration, the diversity and variety of content being displayed in a sports bar for example, makes it difficult for the patrons to hear the audio from any given display or TV. As a result they are limited to watching the event without the benefit of the audio. It is also a common practice for the proprietors and establishment owners to turn off the audio completely.

The invention in its most basic form is designed to capture the audio associated with a displayed video and if necessary, convert it into a digital format and then stream the digital audio over any wireless medium, including but not limited to RF and Infra red to portable consumer products like but not limited to iPods, iPhones, iPads, any number of Android enabled smart phones, laptops, palm computers or blackberry devices just to name a few using an Internet protocol. As an example the wireless medium could be a WIFI network using IEEE 802.11g or any protocol or any other means that evolves in the future that is end user device compatible and capable and has the means to transport audio and/or audio/video media to meet the system needs. It should be noted that the conversion mentioned above could be as complex as taking an analog audio feed and digitizing it, putting it into an Internet compatible format and then distributing it over the premise wireless network. As a result the conversion could be a simple process if the original content is already in a digital format or could be complex if it is in an analog format. As a result the latency delay in preparing and distributing the audio and or audio and video content to the end user will vary in complexity and in the amount of time it takes to complete the conversion process making the latency delay of the content on the in display screen variable in nature.

To better understand the invention and how a person with a portable media receiver like an iPhone would use the system, the following limited and simple example is provided. A customer enters a Sports Bar and sits at a table. Across the room on the wall is a large flat screen television on which a football game is being displayed. The customer would like to hear the play by play commentary but the sound to the TV is not on. Surrounding him are a number of other TV's all having different sporting events on them, so he knows he can't ask the waitress to turn up the sound so he can hear it. He notices that on the wall below the TV set a sign is indicating patrons can hear the audio portion of the program using any WIFI enabled device by downloading an APP from the Apple APP store called “Front Row Wireless”™. The sign also tells him how he can get the appropriate APP for other devices but since he has an iPhone he is only interested in the one provided by Apple. He pulls out his iPhone and goes to the APP store, finds “Front Row Wireless”™ and downloads it. He then runs the APP. The “Front Row Wireless”™ APP in this WIFI example when executed, links the iPhone to the WIFI network in the establishment, allowing the patron to interface with the establishments audio/video distribution system. The patron receives from the establishment's audio/video distribution system, a menu or other form of selection means from which to select the audio/video program they wish to receive. Depending on the device used, the selection means presents the available selections in either an audio or visual basis. In this simple example a number on the wall next to the TV identifies it as screen #5 and the patron select screen #5 and submits his request to the audio/video distribution system. The audio/video distribution system optionally adds the user to a queue or list of devices logged into the audio/video distribution system along with an indicator that the patron wishes to receive audio/video streaming data associated with TV set #5. It should be noted that different devices may require different interface methods or processes and it is not the intention of the inventor to limit the user interface design or the method used to distribute the audio/video content from the audio/video distribution system source to the end user device. Two commonly used methods of distributing the audio and/or audio/video media would be to send streaming data to each end user device individually in increments where the end use device acknowledges receipt of each packet. Services like YouTube operate in the manner. Alternatively, since all of the end user devices are in the same location and using the same network, the media could be broadcast much like radio and TV are today to all end user devices simultaneously by streaming the media to the end user devices using any broadcast capable Internet protocol such as UDP or any other standard like a digital television or radio protocol. Once the end users iPhone in this limited example is logged in, the audio/video distribution system will initiate the streaming of audio data over the establishments WIFI distribution system to the end users phone in a format that best utilizes the available bandwidth of the distribution system and the physical capabilities of the end device. At this point, some additional elements of the system need to be discussed. First, the audio/video distribution system can serve as little as no patrons up to and including a plurality of patrons depending on the events being displayed and the number of people with audio/video capable end devices in the establishment. In every configuration, there would be some degree of latency delay introduced into the system due to the potential of having to convert and/or compress the audio and or audio/video signal received from the service provider and then passing it to the distribution system. The converted and/or compressed audio and/or audio/video signal must then put into a format for transmission and transmitted over the wireless network to each device individually or broadcast to all devices simultaneously (transmission of rounds and sub-rounds or broadcast method). It should be noted that the latency delay increases based on the number of end user devices being serviced and the number of different media channels available and offered by the establishment for distribution. To further illustrate the latency delay issue, compare an establishment with 2 TV's each showing different programs and having 5 customers with end use devices, to an establishment with 12 TV's and 12 different programs being displayed and having a patron loading of 100 communicating end user devices all logged in concurrently. The first example will have a small latency delay in comparison to the second example, which will have a much larger latency delay depending on the media content and method of wireless distribution of the content implemented. To overcome the latency delay issue, the audio/video distribution system within the establishment will take the original audio/video signal from the service provider and will induce a delay in the delivery of the video signal to its associated display device. This configuration tuning will be customizable on a location by location basis. As an example but not to be construed as to limit the invention, the media could be buffered in a memory from which the streaming audio and/or audio/video digitized data would then be extracted and transmitted. By example, this conversion and transmission process at the audio video distribution system for the establishment, using the YouTube example above, will occur in a cyclical manner so that all end user devices will be sent, over the wireless network, a sufficient amount of data from the establishments audio/video system buffer, so that it will not run out of content before it receives its next stream of digitized content or sub-round. For purposes of definition in this limited example, sending a fixed amount of data from the establishment's audio/video distribution system to all the end user devices logged into the system will be called a “round”. For further clarification, a single transaction of sending media to an individual end use device will be called a “sub-round”, where as the transmission of the media sub-rounds to all logged on end user devices is a “round”. A sub-round consists of the transmission of audio and/or audio/video data from the establishment's audio/video distribution system to an individual end user device wherein the end user device responds to the transmission with an acknowledgement. The level of retries to send a sub-round to an end user device is controllable by the system and may be any value including zero. Once a sub-round of digitized data is received and buffered in the end users device, it will initiate a play function which will take data from the buffer of audio and/or audio/video content in its memory and convert it for output to either a speaker, ear bud or other audio generating means. It is important to note that the audio/video distribution system for the establishment will not display the current round video associated with the buffered round until all end user units have received the current round of digitized data. By definition, “all end user units” may or may not have received and acknowledged receipt of the data based on configuration controls mentioned above where such control is managed by the establishments audio/video distribution control system. The reason the system delays or adds a latency delay to the display of the video content is that all end user devices will have to have the audio content for the current round in their memory before the image associated with it is displayed. If this latency delay were not imposed on the establishments displayed content, the video could and would be as a function of a point in time, ahead of the audio distribution to the end user device. This would make the synchronization of the video on the establishment's TV impossible to sync up with the audio content buffered in the end user device. Under the stated process above, the audio content buffered in the end users device would, as a function of a point in time, be ahead of the video content that was held by the latency delay in the establishment audio/video distribution systems buffer. To synchronize the audio in the end users device with the video being displayed on the establishments TV, the APP in the example above which was down loaded from the Apple APP Store would include a synchronization function which would allow the user to manually scroll forward or backward in the buffered audio content in such as way as to allow the user to get the audio in sync with the establishments audio/video distribution system. The design of this synchronization process or method will not be limited to a wheel or slide bar within this disclosure, while these are logical means that end users are accustomed to using. The synchronization process can take on a plurality of forms and the best form for each end use device will be established by the APP developer for each end use device. Based on the speed of available processors and the transmission speed and bandwidth available on most wireless networks the latency delay within an establishment and therefore the synchronization window that the end user will be working within will not be large and should only require minor adjustment to get fully synchronized. One method of synchronization that could be incorporated would be a counter superimposed in one corner of the display screen that counts down to the beginning of a new round. Since the device knows the beginning and ending point for a round and so does the establishment's audio/video distribution system, the distribution system can display a count down window to each round. The APP in this example would have a count down synchronizer button or key that the end user would depress when the counter got to zero. That would place the audio which is buffered in the end users device in very close proximity to the video steam being displayed by the establishment's audio/video distribution system. Some fine turning of the audio sync using a slide bar or wheel might also be used at this point. This example is not meant to limit the method used for synchronization. Another alternate method that would automatically sync the audio and video would be to use a blue tooth signal which that provides a round starting beacon signal that is capable of being detected by smart phones, tablets, iPads, iPods or PC's. Here again this example is not meant to limit the means of automatically synchronizing the audio and video. In the case of the broadcast system alternative mentioned above, where a protocol like UDP or some other form of radio or TV digital broadcast standard is used, synchronization of the audio at the end user device with the video on the establishments display means will not be as difficult to synchronize, but will still be needed and therefore, depending on the level of delay, will provide the same ability for adjusting the delay by the end user to ensure maximum enjoyment of the displayed media. This is the preferred implementation method.

The user will stay logged into the establishment's audio/video distribution system until they log off of the system or move outside the wireless networks coverage area.

The power of the transmitter associated with establishments audio/video distribution system will vary depending on the location size and physical layout. While standards exist for power output and protocols, variations of these will evolve over time permitting higher power outputs to cover larger physical spaces. This power output can be controlled by the audio/video distribution system in a dynamic form to permit coverage of large physical spaces such as a sports arena, concert hall, movie theater or convention hall. These large physical spaces may require FCC permits to exceed power output standards or may adopt high speed repeaters to provide blanket coverage or channel reuse to push the steaming audio/video media to large end user device populations. Use of fiber optics to link repeaters or simulcast transmitters in large venues will be accommodated by the system to provide compete coverage.

To this point, the invention has focus primarily on audio media distribution however it also can include video media content. While most end users in an establishment can see the big screen event directly, some may want to have their own end use device display the video media content as well. As a result not only will the audio media be streamed to the end user device but the video media can also be streamed. When the combined audio and video are steamed to the end user device, there will be no need to synchronize the audio with the video as they will be transmitted using any of a number of standard streaming formats which keep both elements of the media tied directly together. In all instances however the ability to synchronize the audio with the original video display will exist either manually or in an automated fashion so that the end user can for instance watch the event on a big screen in the establishment but if they desire to go to the bathroom or outside to smoke, they can activate the video on their end use device and watch the streamed media without being in direct visual proximity of the establishments display unit. The use of the audio/video distribution system at a live simulcast event in a stadium, arena, concert, theater or convention hall brings an additional end user experience to the event which may be provided as a value added service by the event operator, promoter or establishment operator and may be an additional up sale charge option available to end users to enhance their enjoyment of the event. Access to the establishment's audio/video distribution system can manage the access by end use devices and permit only those with approved access clearance or paid admission to receive the video stream. Paid admission and control as a result would require a security control front end to ensure unauthorized access to the content was property controlled. Security control systems and control access means as well as encryption schemes are all potential vehicles for delivering this added value service while protecting the assets of the promoters and owners of the event or media. As a result the end user can be in the nose bleed section of a simulcast concert or sports arena and by using the establishment's audio/video distribution system be electronically transported to the front row or be on stage with the performers just like a live MTV event. Through this same control system promoters of events such as music concerts can offer for sale though the same system a copy of the entire event in an audio or audio/video format which would be purchased by the end user and then sent to their device using the same wireless network. This type of transfer would require the transmission of rounds of data as described about to ensure that the end user device receives all the content. The UDP streaming broadcast method mentioned above does not require a confirmation that data was received by the end user device and therefore would not be suitable for such a transaction. Transactions of this type could be fashioned after retail media distribution and control store fronts like the Apple iTunes Store. This would permit the customer to commit to a purchase and then download the content to their device immediately after or during the performance or at any time over the Internet

In large arenas were the sound system may have a latency delay due to distance and the end user is often surrounded by crowd noise, the ability of the end user to use their own ear buds to listen to the audio without all the crowd interference would be provided and synchronization of the audio with the performance is essential to enhancing the overall experience. Once again the APP will provide the means for synchronization of the audio with the performance which would utilize the broadcast format of distribution. This synchronization again will not be needed if the patron is receiving and viewing the streaming video and audio as a combined package even though the combined audio and video stream has a latency delay imposed on it.

It will not be possible for an APP to record either the audio or video media steam of either a live or service provider distributed event in an establishment without proper licensing, payment of fees, security clearance and copyright agreements. All of these would be possible and the value added features mentioned above to capture an event for personal use are included as a value added feature of the APP when offered by the establishment operator or the event promoter.

The establishment audio/video distribution system may be incorporated into a cable set top box, a satellite receiver, video display, TV or any other form of video receiving or recording device. The system may also be a stand alone system which uses a processor with memory and video and/or audio means to capture and transmit the media content of any attached cable, over the air or satellite receiver. The media may come from an end service provider such as a cable company, a television station, a satellite provider or an Internet media distribution company like Netflix as an example but is not limited to these types or providers. One preferred embodiment, for example, would incorporate the media distribution system directly into a satellite receiver so that it can be paired directly with a display unit in a commercial establishment, a business or a home. In its simplest form, the device could be a simple receiver with no display capability and no transmitter that scans all available streaming ports for UDP steaming audio data and plays it through a set of ear buds or other sound emitting means for the enjoyment of the end user. This simple form could be a simple set of head phones with a receiver, a button means to cause the turner to scan for the next available signal in a looping scan process and may optionally have a knob or thumb control rotary means to advance or retard the playback media it receives. The simplest form could also have a single button that when pressed would scan for the next available streaming audio port on a network and plays it just like the scan feature on a car radio. This simplest form could optionally be made to work only with a specific establishments' audio and/or audio/video distribution system and made available to customers for rental or loan while in the establishment. The loaner or rental units would have a separate receive from the headset so that the headset would be disposable for sanitary reasons. This type of simplest form device would be an excellent marketing tool to be used by establishments to attract new customers and improve the overall experience of existing customers. This simplest form would receive configuration data from the designed control channel of the audio and/or audio/video distribution system which would only allow it to work in that establishment. This process is covered in more detail in the FIG. 7-0 description. The simplest form end user device can also have an RFID chip embedded in it to help prevent them leaving the establishment just like a security tag placed inside merchandise in a retail store.

Obviously, many modifications and variations of the present invention are possible in light of the above teachings. The invention may be practiced otherwise than as specifically described within the scope of the appended claims.

What is claimed is:

1. An audio/video distribution system for providing media to an end-user, the media having an audio component and a video component, at least the audio component being received and played at an end-user device, comprising:
a controller for receiving an audio/video signal and responsively generating separate video and audio signals, the video signal having a predetermined delay introduced by the controller;
a display device coupled to the controller for receiving and displaying the video signal; and,
a synchronization tool implemented at the end-user device, the synchronization tool being configured to allow a user to synchronize playback of the audio signal at the end-user device to the display of the video signal at the display.

2. A system, as set forth in claim 1, the audio signal being buffered within the end-user device, the synchronization tool in allowing the user to synchronize the playback of the audio component being configured to allow the user to scroll forward and backward within the buffered audio signal.

3. A system, as set forth in claim 1, the synchronization tool being configured to display an adjustment member which may be manipulated by the user to synchronize the playback of the audio signal with the display of the video signal.

4. A system, as set forth in claim 3, wherein the adjustment member is one of a wheel and a slide bar.

5. A system, as set forth in claim 1, the controller being configured to display a counter on the display device, the synchronization tool being configured to display an element actuatable by the user to indicate when the counter has reached a predetermined value, the synchronization tool configured to playback the audio signal in response to the element being actuated.

6. A system, as set forth in claim 5, the synchronization tool being configured to display a fine adjustment member which may be manipulated by the user to provide fine synchronization of the playback of the audio signal with the display of the video signal.

7. A system, as set forth in claim 6, wherein the fine adjustment member is one of a wheel and a slide bar.

8. A system, as set forth in claim 1, the controller being configured to receive an audio/video signal and to responsively separate the audio/video signal into the audio signal and the video signal.

9. A system, as set forth in claim 1, wherein the audio signal is transmitted wirelessly to the end-user device.

10. A system, as set forth in claim 1, wherein the audio signal is transmitted to the end-user device through a computer network.

11. A system, as set forth in claim 10, wherein the computer network includes the Internet.

12. A system, as set forth in claim 1, wherein the end-user device being a smart phone or other mobile device.

13. A method of distributing media to user, the media having an audio component and a video component, at least the audio component being received and played at the end-user device, including the steps of:
receiving an audio/video signal and responsively generating separate video and audio signals using a controller, the video signal having a predetermined delay introduced by the controller;
receiving and displaying the video signal at a display device, the display device being separate from the end-user device; and,
allowing a user to synchronize playback of the audio signal at the end-user device to the display of the video signal at the display using a synchronization tool implemented at the end-user device.

14. A method, as set forth in claim 13, the audio signal being buffered within the end-user device, the step of allowing the user to synchronize the playback of the audio component including the step of allowing the user to scroll forward and backward within the buffered audio signal.

15. A method, as set forth in claim 13, including the step of displaying an adjustment member which may be manipulated by the user to synchronize the playback of the audio signal with the display of the video signal.

16. A method, as set forth in claim 15, wherein the adjustment member is one of a wheel and a slide bar.

17. A method, as set forth in claim 13, including the steps of:
displaying a counter on the display device;
displaying an element on the end-user device, the element being actuatable by the user to indicate when the counter has reached a predetermined value; and
playing the audio signal at the end-user device as a function of the element being actuated.

18. A method, as set forth in claim 17, displaying a fine adjustment member which may be manipulated by the user to provide fine synchronization of the playback of the audio signal with the display of the video signal.

19. A method, as set forth in claim 18, wherein the fine adjustment member is one of a wheel and a slide bar.

20. A method, as set forth in claim 13, including the step of receiving an audio/video signal and responsively separating the audio/video signal into the audio signal and the video signal.

21. A method, as set forth in claim 13, wherein the audio signal is transmitted wirelessly to the end-user device.

22. A method, as set forth in claim 13, wherein the audio signal is transmitted to the end-user device through a computer network.

23. A method, as set forth in claim 22, wherein the computer network includes the Internet.

24. A method, as set forth in claim 13, wherein the end-user device being a smart phone or other mobile device.
